(19) United States
(12) Patent Application Publication
(10) Pub. No.: US 2025/0168812 A1
(43) Pub. Date: May 22, 2025

(54) PRECISION FINDING WITH EXTENDED RANGE

(71) Applicant: QUALCOMM Incorporated, San Diego, CA (US)

(72) Inventors: Feliciano GOMEZ MARTINEZ, Los Gatos, CA (US); Suman MURARI, San Diego, CA (US); Derek PARK, Fremont, CA (US); Javier DEL PRADO PAVON, Los Gatos, CA (US)

(21) Appl. No.: 18/954,431

(22) Filed: Nov. 20, 2024

Related U.S. Application Data
(60) Provisional application No. 63/601,397, filed on Nov. 21, 2023.

(51) Int. Cl. H04W 64/00; H04B 1/7163; H04W 8/22; H04W 84/12

(52) U.S. Cl. CPC H04W 64/00; H04B 1/7163; H04W 8/22; H04W 84/12

(57) ABSTRACT

A method for precision finding with two radio technologies includes: determining a first distance to a wireless node based at least in part on a first positioning technology having a capability of determining distances to objects within a first range; determining, based on the first distance being within a second range, a second distance to the wireless node based on a second positioning technology having a capability of determining distances to objects up to the second range, wherein the second range is less than the first range; and outputting location information for the wireless node based at least in part on the second distance.

### CROSS-REFERENCE TO RELATED APPLICATIONS

This application claims the benefit of U.S. Provisional Application No. 63/601,397, filed Nov. 21, 2023, entitled “PRECISION FINDING WITH EXTENDED RANGE,” which is assigned to the assignee hereof, and the entire contents of which are hereby incorporated herein by reference for all purposes.

### BACKGROUND

### Field of the Disclosure

The disclosure relates to positioning, and more specifically to precision finding with extended range.

### Description of Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

It is often desirable to know the location of a user equipment (UE), e.g., a cellular phone, with the terms “location” and “position” being synonymous and used interchangeably herein. A location services (LCS) client may desire to know the location of the UE and may communicate with a location center in order to request the location of the UE. The location center and the UE may exchange messages, as appropriate, to obtain a location estimate for the UE. The location center may return the location estimate to the LCS client, e.g., for use in one or more applications.

Obtaining the location of a mobile device that is accessing a wireless network may be useful for many applications including, for example, emergency calls, personal navigation, asset tracking, locating a friend or family member, etc. Other short range communications technologies may be used for positioning applications. For example, a mobile device may communicate using a short range communication technology such as WiFi, Bluetooth® (BT), ultrawideband (UWB), millimeter wave (mmWave), etc. Existing positioning methods include methods based on measuring radio signals transmitted from a variety of devices including satellite vehicles and terrestrial radio sources in a wireless network such as base stations and access points.

### SUMMARY

An example method of determining location information for a user equipment (UE) based on a distance to a wireless node includes: transferring, at a first time, a first positioning signal between the UE and the wireless node based at least in part on a first positioning technology having a capability of determining distances to objects up to a first range; transferring, at a second time after the first time, a second positioning signal between the UE and the wireless node based on a second positioning technology having a capability of determining distances to objects within a second range that is greater than the first range; determining a distance between the UE and the wireless node based on the second positioning signal; and outputting the location information for the wireless node based at least in part on the distance between the UE and the wireless node.

An example method for determining a distance to a wireless node includes: receiving location information for the wireless node; determining a first distance to the wireless node based on the location information; performing a first signal exchange with the wireless node in response to the first distance being below a first threshold value; determining a second distance to the wireless node based on the first signal exchange; performing a second signal exchange with the wireless node in response to the second distance being below a second threshold value; and determining a third distance to the wireless node based on the second signal exchange.

An example method for precision finding with two radio technologies includes: determining a first distance to a wireless node based at least in part on a first positioning technology having a capability of determining distances to objects within a first range; determining, based on the first distance being within a second range, a second distance to the wireless node based on a second positioning technology having a capability of determining distances to objects up to the second range, wherein the second range is less than the first range; and outputting location information for the wireless node based at least in part on the second distance.

An example for selecting a positioning technology includes: determining a first location associated with a user equipment; determining a second location associated with a wireless node; selecting the positioning technology based on the first location and the second location; and determining a distance or a direction from the user equipment to the wireless node based on the positioning technology.

Items and/or techniques described herein may provide one or more of the following capabilities, as well as other capabilities not mentioned. A first mobile device may desire to locate a second mobile device. The second mobile device may be associated with another user (e.g., a smart phone) or other assets (e.g., vehicle, asset tag). The first mobile device may receive location information associated with the second mobile device via a network. The location information may be based on a satellite based position obtained by the second mobile device. The first mobile device may utilize the location information to determine a distance and direction to the second mobile device. The first mobile device and the second mobile device may initiate a signal exchange when they are within communication range of one another. In an example, WiFi® short-range wireless communication technology ranging exchanges may be used to determine a distance between the mobile devices. The first mobile device may be configured to update a displayed distance to the second mobile device based on the WiFi® signal exchange. Other device-to-device radio access technologies (D2D RATs), such as ultrawideband (UWB) may be used to determine distance and direction information. For example, the mobile devices may be configured to perform a UWB ranging exchange when they are within UWB communication of one another. Updated distance and direction information based on the UWB exchange may be displayed on the first mobile device. The progression through the different positioning technologies may increase the efficiency and precision of finding operations. Other capabilities may be provided and not every implementation according to the disclosure must provide any, let alone all, of the capabilities discussed.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server, various examples of which are shown in FIG. 1.

FIG. 5 is a block diagram of an example communications module with multiple transceivers.

FIG. 6 is an example message flow for a round trip time measurement session.

FIG. 7A is a diagram of example signal exchanges for UWB ranging.

FIG. 7B is a diagram of an example angle of arrival of an RF signal.

FIG. 8 is a diagram of an example use case for precision finding with extended range.

FIG. 9A is a diagram of example precision regions based on different radio access technologies.

FIG. 9B is an example user interface for precision finding with extended range.

FIG. 10 is an example signal and processing flow diagram for network controlled precision finding operations.

FIG. 11 is a process flow diagram of an example method for determining location information for a user equipment based on ranges to a wireless node.

FIG. 12 is a process flow diagram of an example method for determining a range to a wireless node.

FIG. 13 is a process flow diagram of a method for configuring a precise finding operation.

FIG. 14 is a process flow diagram of a method for precision finding with two radio technologies.

FIG. 15 is process flow diagram of a method for selecting a positioning technology.

### DETAILED DESCRIPTION

Techniques are discussed herein for determining the locations of wireless devices. In an example use case, a user of a wireless device (e.g., a mobile phone) may desire to determine the location of another wireless device, such as a device tag or another mobile phone user (e.g., a family member, friend, etc.) in a crowded area (e.g., a concert, a mall, a beach, etc.). An approach to assist a first user in finding a second user (and vice versa) may include displaying location information in a vector indicating “distance” and “direction” (e.g., a range and bearing) to one another. The users may then walk in the respective directions until they find each other. Other approaches may utilize top down map views of the respective locations, and the users may interpret their respective locations and the map and walk toward one another. Some users, however, struggle with interpreting the map information and prefer the vector approach. In such use cases, the distance and direction information should be accurate enough to enable the mobile devices to find a precise location of another device as the range reduces.

In operation, the techniques provided herein utilize different radio access technologies as the distance between the wireless nodes decreases. In general, a precision finding operation requires the determination of distance and direction to another device. For short ranges, when a target wireless node is nearby, UWB techniques may be used to determine the distance and direction from a finder device to a target device. Distance may be measured using UWB RTT (Round Trip Time), and direction may be measured using UWB angle-of-arrival (AoA). The effective range of UWB, however, is limited due to regulatory limits on transmit power. In an example, when the target device is outside the range of UWB (e.g., greater than 100-200 m), other radio access technologies may be used. For example, RTT exchanges may be performed using WiFi to determine a range to the target device. In some implementations, WiFi may also be used to obtain AoA information. When the target device is beyond WiFi range (e.g., greater than 300 m) terrestrial and satellite navigation techniques may be used to determine the locations of the finder and target devices and the distance and direction vector information may be displayed based on the two locations. For example, a cellular network, or other wireless communication link, may be used to provide the respective locations of the finder and target devices. Other radio frequency range and direction finding techniques and mobile device configurations, however, may be used.

Particular aspects of the subject matter described in this disclosure may be implemented to realize one or more of the following potential advantages. The efficiency and accuracy of device finding applications may be increased. Signal transfers using various device-to-device radio access technologies (D2D RATs) (e.g., WiFi, BT, UWB, Sidelink NR, mmWave) may reduce the network signaling overhead required to obtain and disseminate the positions of a finder and target device. Other advantages may also be realized.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, automobile, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® short-range wireless communication technology networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

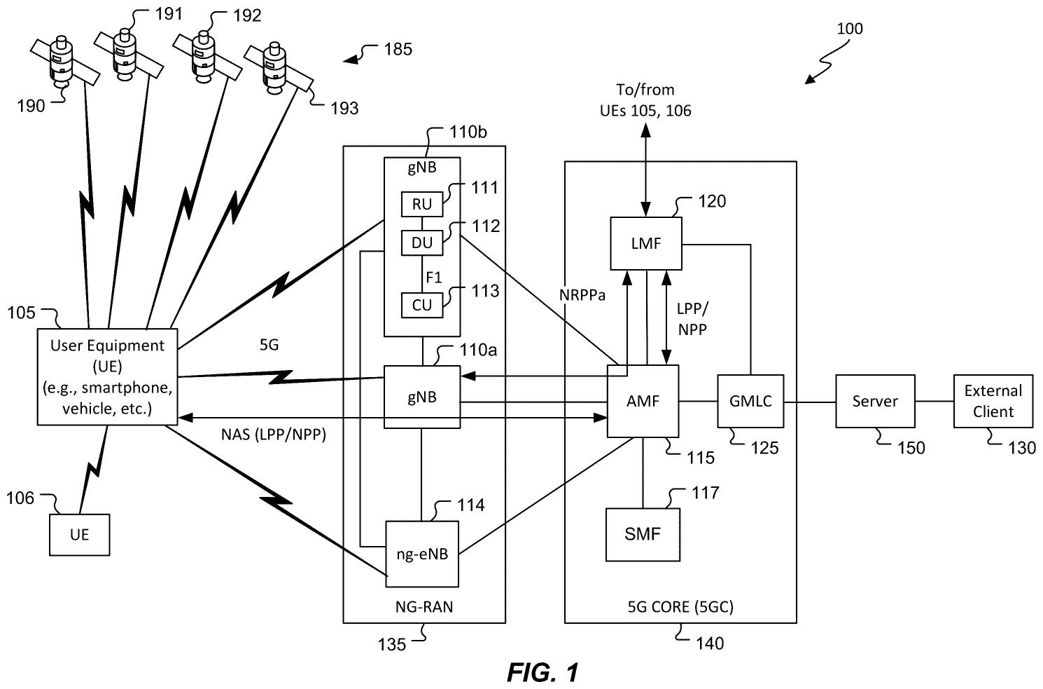

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi® short-range wireless communication technology, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some examples, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

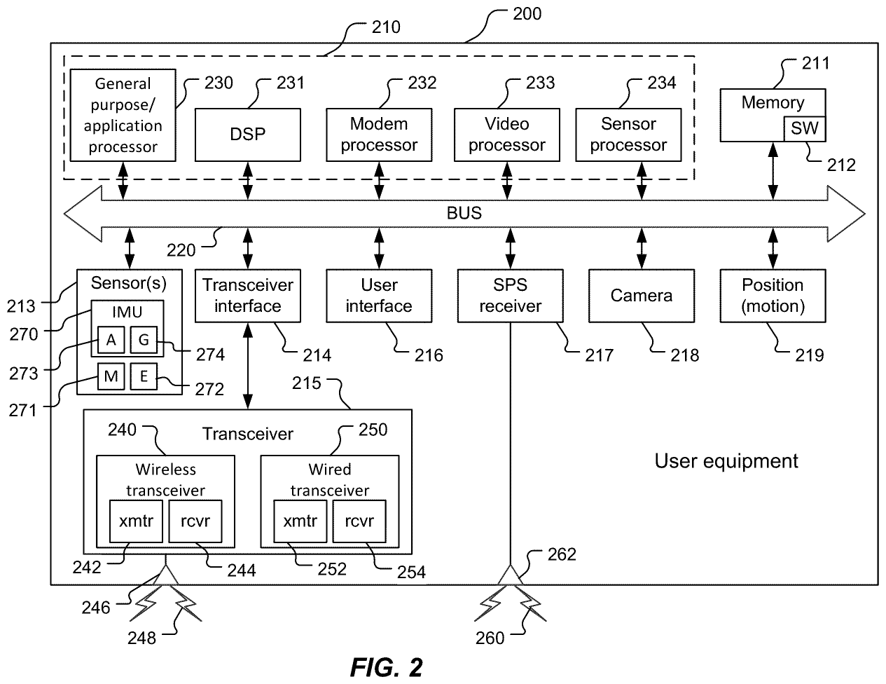

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise, for example, one or more accelerometers 273 (e.g., collectively responding to acceleration of the UE 200 in three dimensions) and/or one or more gyroscopes 274 (e.g., three-dimensional gyroscope(s)). The sensor(s) 213 may include the one or more magnetometers 271 (e.g., three-dimensional magnetometer(s)) to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations. The sensor(s) 213 may comprise one or more of other various types of sensors such as one or more optical sensors, one or more weight sensors, and/or one or more radio frequency (RF) sensors, etc.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and the gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to guided signals, e.g., wired electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

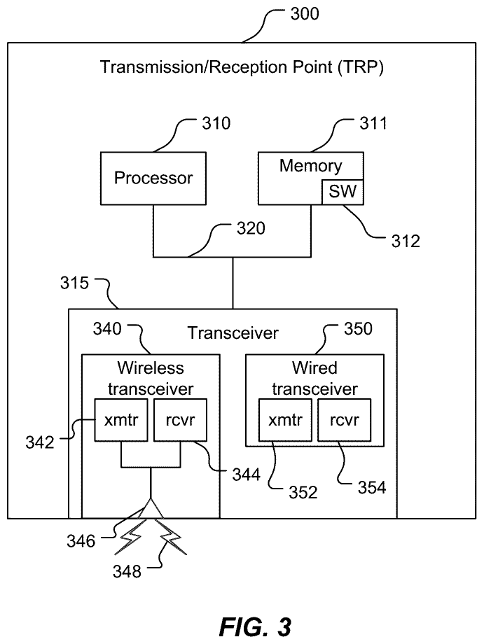

Referring also to FIG. 3, an example of a TRP 300 of the gNBs 110a, 110b and/or the ng-eNB 114 may comprise a computing platform including a processor 310, memory 311 including software (SW) 312, and a transceiver 315. Even if referred to in the singular, the processor 310 may include one or more processors, the transceiver 315 may include one or more transceivers (e.g., one or more transmitters and/or one or more receivers), and/or the memory 311 may include one or more memories. The processor 310, the memory 311, and the transceiver 315 may be communicatively coupled to each other by a bus 320 (which may be configured, e.g., for optical and/or electrical communication). One or more of the shown apparatus may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to guided (e.g., wired electrical and/or optical) signals and from guided (e.g., wired electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

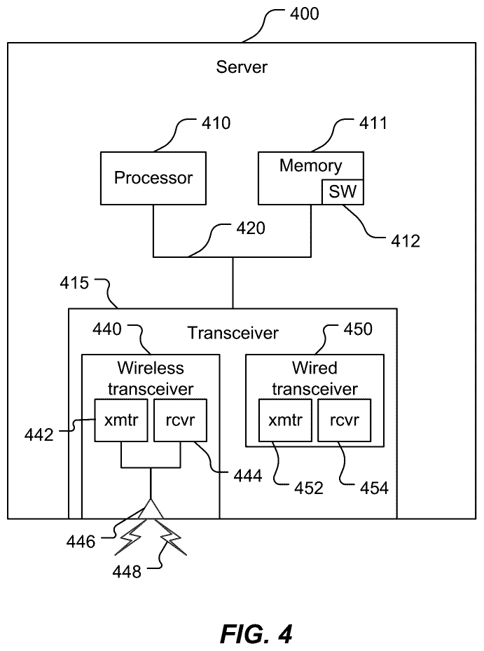

Referring also to FIG. 4, a server 400, of which the LMF 120 may be an example, may comprise a computing platform including a processor 410, memory 411 including software (SW) 412, and a transceiver 415. Even if referred to in the singular, the processor 410 may include one or more processors, the transceiver 415 may include one or more transceivers (e.g., one or more transmitters and/or one or more receivers), and/or the memory 411 may include one or more memories. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to guided (e.g., wired electrical and/or optical) signals and from guided (e.g., wired electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity.

Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{RX→Tx}, and subtracting the UE_{Rx-Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

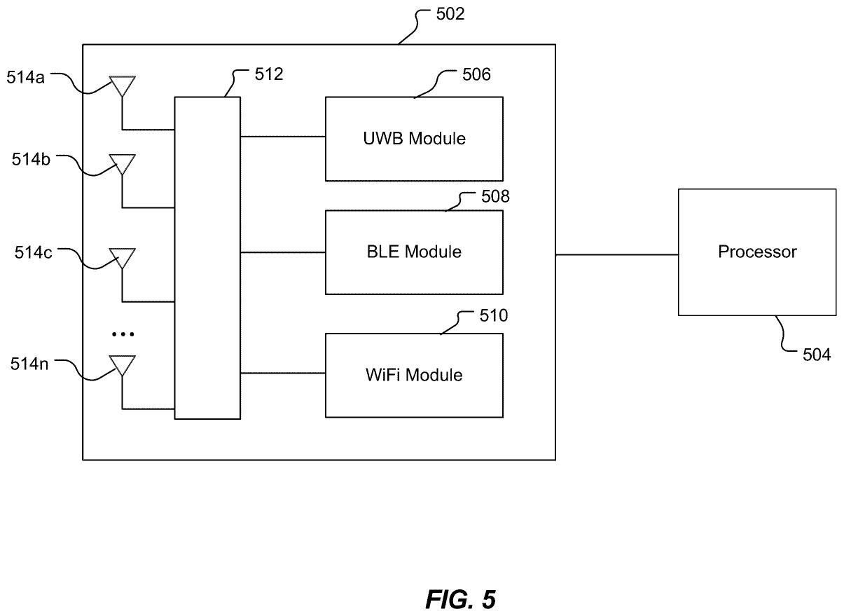

Referring to FIG. 5, a block diagram of an example communications module 502 with multiple transceivers is shown. The communications module 502 may be used as a transceiver in a mobile device, such as the transceiver 215 in the UE 200, or a transceiver in a base station, such as the transceiver 315 in the TRP 300. Other devices, such as smart tags, tables, laptop computers, etc. may have some or all of the components of the communications module 502. In an example, in a V2X network, the communications module 502 may be included in a Roadside Unit (RSU). The communications module 502 may be communicatively coupled to a processor 504, such as the general-purpose processor 230 and/or the modem processor 232. One or more RF modules such as a UWB module 506, a BT or BLE module 508, and a WiFi module 510 may be communicatively coupled to a plurality of antennas 514a, 514b, 514c, . . . , 514n via one or more multiplexers 512. The multiplexers 512 may include switches, phase shifters, and tuning circuits configured to enable one or more of the RF modules 506, 508, 510 to send and receive signals via one or more of the antennas 514a-514n. For example, the WiFi module 510 and the UWB module 506 may be configured to utilize one or more of the antennas 514a-514n based on operational frequencies. The phase shifters, and other components within the multiplexers 512, may enable beamforming to increase the transmit or receive gain on different angles from the antennas 514a-514n. In an example, the BLE module 508 and the processor 504 may be configured for Bluetooth® channel sounding (BTCS) which may utilize a combination of round trip time (RTT) and round trip phase (RTP) measurement techniques. BTCS may be configured to obtain angle information. One or more of the RF modules 506, 508, 510 may be configured to perform the precision finding techniques, including obtaining signals configured for distance and direction computations, as described herein.

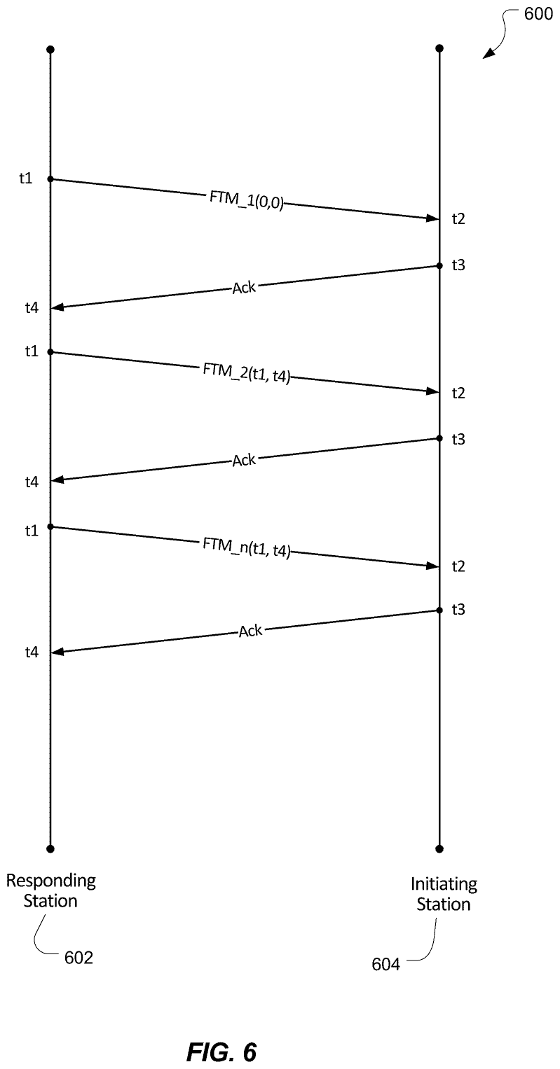

Referring to FIG. 6, an example of a round trip time measurement session 600 is shown. The general approach includes signal transfer between a responding station 602 and an initiating station 604. The responding station 602 and the initiating station 604 may be finder and target wireless devices, such as the UE 200, or other wireless mobile devices configured to participate in time-of-flight based positioning. In an example, and not a limitation, the RTT measurement session 600 may be based on Fine Timing Measurement (FTM) messages exchanged between the responding and initiating stations 602, 604. Signal transfers are referred to herein as exchanges, even if a signal is transferred independently (e.g., not in response to reception of another signal and/or not requiring a reply signal transfer). Other messages and signals such as positioning reference signals (PRS), sounding reference signals (SRS), Infra-Red camera signals, and/or other reference signals may be used to determine time-of-flight information between two mobile devices. The RTT measurement session 600 may utilize an FTM Protocol (e.g., 802.11mc D4.3 section 10.24.6) to enable two stations to exchange round trip measurement frames (e.g., FTM frames). The initiating station 604 may compute the round trip time by recording the TOA (e.g., t2) of the FTM frame from the responding station 602 and recording the TOD (Time Of Departure) of an acknowledgement frame (ACK) of the FTM frame (e.g., t3). The responding station 602 may record the TOD of the FTM frame (e.g., t1) and the TOA of the ACK received from initiating station 604 (e.g., t4). Variations of message formats may enable the timing values to be transferred between the responding and initiating stations 602, 604. The RTT is thus computed as:

$$RTT = [ ( t 4 - t 1 ) - ( t 3 - t 2 ) ] \qquad ( 1 )$$

The RTT measurement session 600 may allow the initiating station 604 to obtain a range to the responding station 602. An FTM session is an example of a ranging technique between the responding station 602 and the initiating station 604. Other ranging techniques such as TDOA, TOA/TOF (Time Of Flight) may also be used to determine the relative positions of the two stations. Other signaling may also be used to enable a negotiation process, the measurement exchange(s), and a termination process. For example, Wi-Fi 802.11az Ranging Null Data Packet (NDP) and Trigger-Based (TB) Ranging NDP sessions may also be used.

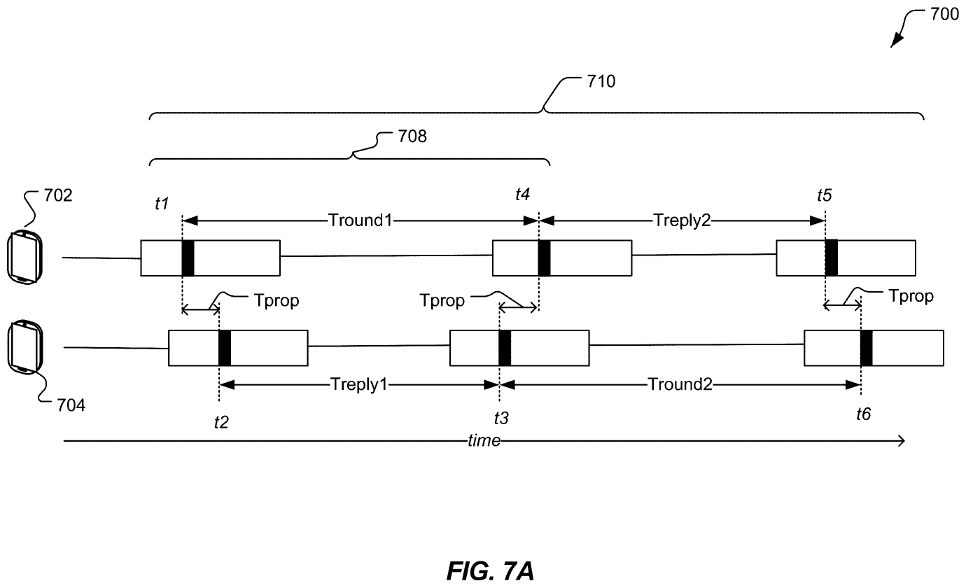

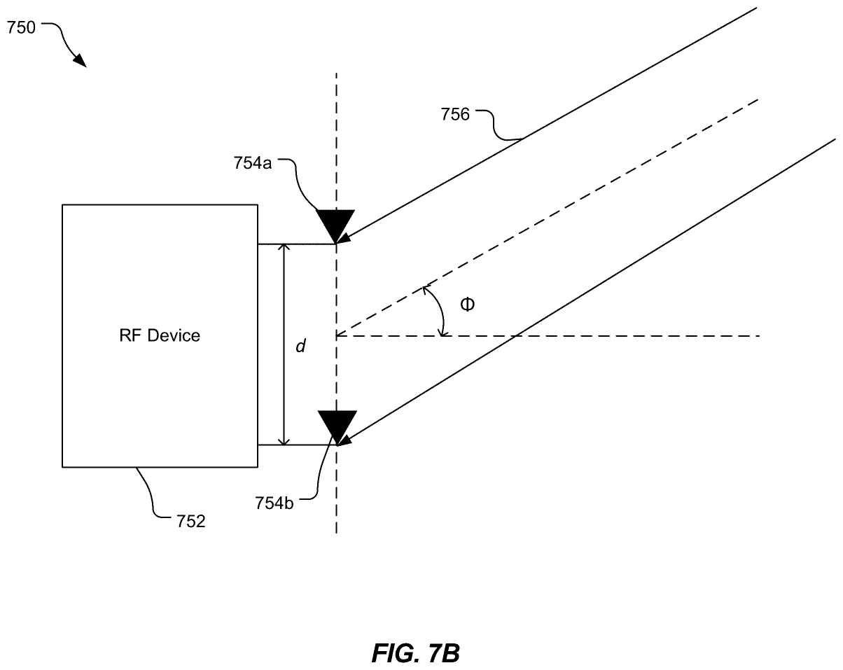

Referring to FIG. 7A, a diagram 700 of example signal exchanges for UWB ranging is shown. The diagram 700 includes a first UWB device 702 and a second UWB device 704 (e.g., finder and target devices, such as smartphones and/or device tags). The UWB devices 702, 704 may include some or all of the components of the UE 200. The UE 200 is an example of the first UWB device 702 and/or the second UWB device 704. Each of the UWB devices 702, 704 may include one or more transceivers configured to send and receive UWB signals, such as depicted in the communications module 502. The signal exchanges may be based in the IEEE 802.15.4 standard and may utilize the physical layer (PHY) and media access control (MAC) sublayers to enable secure ranging. The positioning exchanges may also utilize IEEE 802.15.4z security features such as STS in the UWB ranging frame to prevent preamble insertion attacks. In a first example, the UWB signals may comprise a single-sided two-way ranging exchange 708 such that the first UWB device 702 may transmit a ranging marker at time t1 which may be received by the second UWB device 704 at time t2. The second UWB device 704 may send an acknowledgement frame at time t3, which may be received by the first UWB device 702 at time t4. A first round time (Tround1) is equal to t4-t1, and a first reply time (Treply1) is equal to t3-t2. The second UWB device 704 may be configured to provide the Treply1 time to the first UWB device 702. The first UWB device 702 may compute a first round trip propagation time:

$$Tprop 1 = Tround 1 - Treply 1 \qquad ( 2 )$$

The distance between the first UWB device 702 and the second UWB device 704 is equal to:

$$distance = c * ( Tprop 1 / 2 ) \qquad ( 3 )$$

$$where$$

$$c = the speed of light .$$

In a second example, the signals may comprise a double-sided two-way ranging exchange 710 such that the first UWB device 702 may also transmit an acknowledgment at time t5 which may be received by the second UWB device 704 at time t6. The first UWB device 702 may provide a second reply time (Treply2) (i.e., t5-t4) to the second UWB device 704. The Tprop time may be computed as:

$$Tprop = ( ( Tround 1 * Tround 2 ) - ( Treply 1 * Treply 2 ) ) / ( Tround 1 + Tround 2 - Treply 1 - Treply 2 ) \qquad ( 4 )$$

The propagation times (i.e., Tprop) represent the time-of-flight (ToF) of the respective signals between the UWB devices 702, 704 and may be used to determine the distance between the UWB devices 702, 704. In operation, a UWB device may be configured to determine distances up to 100-200 m with an accuracy of approximately +/−10 cm.

Referring to FIG. 7B, a diagram 750 of an example angle of arrival of an RF signal is shown. The diagram 750 includes an RF device 752 (e.g., WiFi, BT, UWB, Sidelink NR, or other D2D RAT) with a plurality of antennas 754a, 754b in an antenna array. An RF signal 756 may be detected at an angle of arrival (AoA) Φ by the antenna array. In general, the AoA is based on a time difference between the arrival of the RF signal 756 at each of the antennas 754a, 754b in the antenna array. The time delay between the arrival of the signals may be determined as:

$$t = d * sin Φ / c \qquad ( 5 )$$

where,
   t is the time delay;
   d is the distance between the antennas;
   Φ is the AoA; and
   c is the speed of light.

In operation, the RF device 752 may utilize UWB technologies and be configured to determine an AoA with an accuracy of approximately +/−1.5 degrees. BTCS technologies may also be used to obtain AoA information. Other radio technologies and transceiver/antenna configurations may realize different accuracy results. For example, WiFi AoA measurements may be obtained with higher end wireless nodes with suitable antenna arrays.

The two-dimensional (2D) AoA measurement depicted in FIG. 7B is an example, and not a limitation. Similar procedures may be implemented with three-dimensional (3D) antenna arrays to compute an angle of elevation (AoE). In some use cases, a first radio technology may be utilized to obtain 2D AoA measurements, and a second radio technology may be utilized to obtain 3D AoA and AoE measurements. In other use cases, a first radio technology may be utilized to obtain AoA measurements for a target, and a second radio technology may be utilized to obtain the AoE measurements for the target.

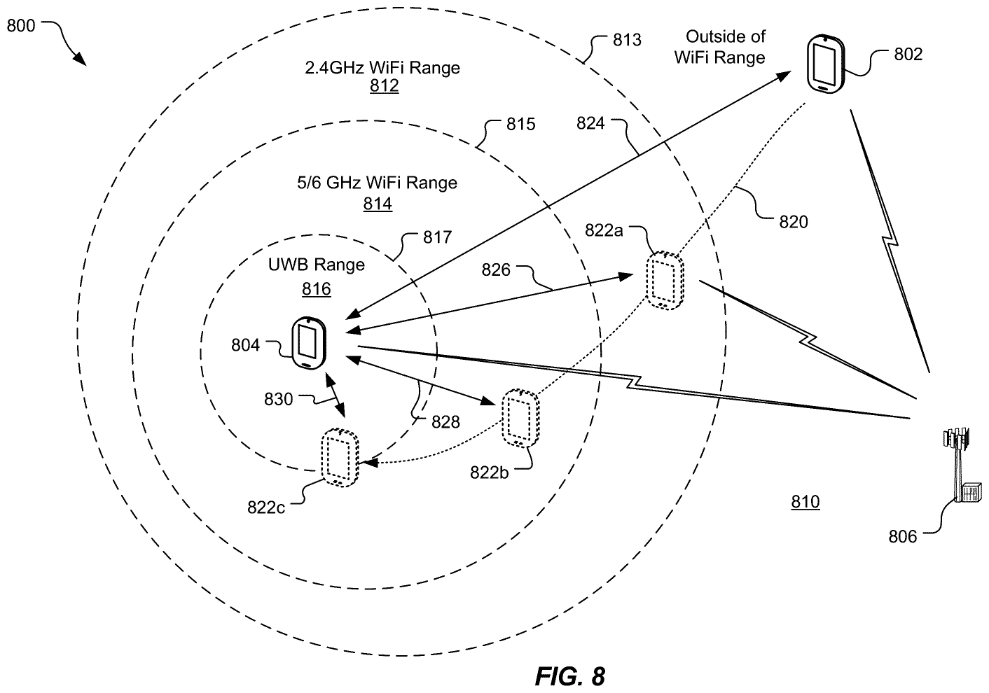

Referring to FIG. 8, a diagram of an example use case 800 for precision finding with extended range is shown. The use case 800 includes a first mobile device 802 and a second mobile device 804. In this example, the first mobile device 802 may be a finder device and the second mobile device 804 may be the target device. In other examples, both of the mobile devices 802, 804 may be finder and target devices (e.g., each device is providing respective position indications to the other device). The mobile devices 802, 804 may include some or all of the components of the UE 200, and the UE 200 is an example of one or more of the mobile devices 802, 804. The mobile devices 802, 804 may be part of a cellular network, or other network, and configured to provide position information via the network. For example, one or more base stations, such as a gNB 806, may be configured to communicate with one or more of the mobile devices 802, 804. The gNB 806 may include some or all of the components of the TRP 300, and the TRP 300 is an example of the gNB 806. In an example, referring to the communication system 100, the gNB 806 may be included in the NG-RAN 135. The gNB 806, and potentially other base stations, may have a network coverage area 810 which includes both of the mobile devices 802, 804. In an example, the second mobile device 804 may be a tag, consumer device asset tracker, pet tracker, or other communications system configured with multiple transceivers, such as described with respect to FIG. 5.

In operation, the first mobile device 802 may initiate a finder application to attempt to find the second mobile device 804 via radio frequency signals. A first distance 824 between the mobile devices 802, 804, corresponding to an initial arrangement of the mobile devices 802, 804, may be greater than an established 2.4 GHz WiFi range 812. Based on this initial arrangement, the mobile devices 802, 804 may obtain respective positions via terrestrial and/or satellite techniques. For example, a location server (e.g., the LMF 120) may be configured to perform a positioning session with one or more of the mobile devices 802, 804 to obtain position information based on downlink and/or uplink positioning reference signal transmissions. In an example, the mobile devices 802, 804 may include SPS receivers 217 and may obtain respective positions via a GNSS. The mobile devices 802, 804 may be configured to exchange location information directly and/or via one or more networked servers (e.g., LMF 120, external client 130). The first mobile device 802 (e.g., the finder device) may be configured to utilize the received location information to generate vector information (e.g., distance and direction) to indicate the relative location of the second mobile device 804 (e.g., the target device).

The user of the first mobile device 802 may proceed along a trajectory 820 towards the second mobile device 804 based on vector information presented by the first mobile device 802 (e.g., a pointing arrow or other visual, audible, and/or haptic output to indicate the relative direction of the second mobile device 804). The first mobile device 802 may reach a first intermediate location 822a which is within the established 2.4 GHz WiFi range 812 and may be configured to perform RTT exchanges (as described with respect to FIG. 6) with the second mobile device 804 to determine a second distance 826 between the mobile devices 802, 804. The 2.4 GHz WiFi range 812 is a region within which 2.4 GHz signaling may be used to determine a distance between the first mobile device 802 and the second mobile device 804 (e.g., 2.4 GHz WiFi signals may be received with sufficient energy to be used to determine the distance between the mobile devices 802, 804 (e.g., with at least a first threshold accuracy (e.g., an uncertainty below a first threshold uncertainty and/or a distance error below a first threshold distance error))). The 2.4 GHz WiFi range 812 may be based on signal strength information (e.g., RSSI) measured by the first mobile device 802 such that the mobile devices 802, 804 may exchange RTT messages when the 2.4 GHz WiFi signal strength reaches an established threshold. Other station discovery techniques may also be used. In an example, a boundary 813 of the established 2.4 GHz WiFi range 812 may be based on expected range values stored in a data structure on the first mobile device 802 (e.g., a look-up-table, flat file, etc. stored in the memory 211). The first mobile device 802 may be configured to apply the stored range value to the current locations of the mobile devices 802, 804 to determine whether the mobile devices 802, 804 are within WiFi range of one another. In an example, a network resource (e.g., the LMF 120) may be configured to provide the expected WiFi and other range values to the mobile devices 802, 804 via network signaling (e.g., LPP, Radio Resource Control (RRC)). A network resource may be configured to provide an indication to the first mobile device 802 when the mobile devices 802, 804 are within the range of a D2D RAT (e.g., WiFi, BT, UWB, Sidelink NR, etc.) of one another. For example, the gNB 806 may be configured to utilize high-level (e.g., LPP, RRC) or low-level messaging (e.g., downlink control information (DCI), medium access control (MAC) control elements (CE)) to provide indications when the mobile devices 802, 804 are within D2D RAT range(s) of one another. For example, respective trigger signals may be transmitted by the gNB 806 when the mobile devices 802, 804 are within range of one another based on WiFi, BT, UWB, Sidelink NR, mmWave, or other device-to-device radio access technology(ies). Other signaling techniques may also be used. In an example, a network resource may be configured to provide channel parameters, security information, and other RF configuration information, to the mobile devices 802, 804 to enable the mobile devices 802, 804 to securely exchange RTT messages. For example, the RTT packets may be encrypted to reduce the chance of man-in-the-middle attacks and meaconing or other spoofing operations on the mobile devices 802, 804. For example, keys associated with the Advanced Encryption Standard (AES) may be provided to the mobile devices 802, 804 via out-of-band (e.g., secure) communications and the RTT messages may be encrypted based on the established keys. The RTT configuration information may be provided in response to the mobile devices 802, 804 being within D2D RAT range of one another.

The mobile devices 802, 804 may continue to provide and/or exchange terrestrial and/or satellite position information while within D2D RAT range of one another. For example, the first mobile device 802 may utilize a combination of distance measurements obtained via 2.4 GHz WiFi RTT exchanges and the locations obtained via GNSS to determine the second distance 826. Some mobile devices may not be capable of determining AoA information for WiFi signals and the direction (e.g., bearing) to a target device may be based on the GNSS (or terrestrial) position information. The mobile devices 802, 804 may continue to exchange ranging messages as the first mobile device proceeds along the trajectory 820 and is within a boundary of the 2.4 GHz WiFi range 812. In an example, the mobile devices may be configured to utilize another D2D RAT (e.g., 5/6 GHz WiFi) which may enable increased accuracy within a decreased range. The first mobile device 802 may arrive at a second intermediate location 822b that is within a 5/6 GHz WiFi range 814. The 5/6 GHz WiFi range 814 is a region within which 5/6 GHz signaling may be used to determine a distance between the first mobile device 802 and the second mobile device 804 (e.g., 5/6 GHz WiFi signals may be received with sufficient energy to be used to determine the distance between the mobile devices 802, 804 (e.g., with at least a second threshold accuracy (e.g., an uncertainty below a second threshold uncertainty and/or a distance error below a second threshold distance error))). The second threshold accuracy may be different from, e.g., finer, than the first threshold accuracy (e.g., the second threshold uncertainty may be lower than the first threshold uncertainty and/or the second threshold distance error may be less than the first threshold distance error. The location of a 5/6 GHz WiFi boundary 815 may be based on signal strength information, expected range information (e.g., data structures), WiFi packet exchanges, and/or provided by a network resource (e.g., network signaling) as previously described. Other station discovery techniques may also be used. The mobile devices 802, 804 may exchange RTT messages utilizing 5/6 GHz technology to obtain a fourth distance 828 between one another. The configuration parameters (e.g., channel information, security protocols, etc.) may be exchanged via the 2.4 GHz connection, and/or the cellular network as described above. In an example, at least one of the mobile devices 802, 804 may be configured to determine AoA and/or AoE information based on the WiFi signals and utilize the AoA and/or AoE for a direction estimate. For example, the second mobile device 804 may be configured to determine an AoA of the RF signals transmitted by the first mobile device 802, and then provide the AoA information via the WiFi link and/or via the cellular network. AoE information may also be determined and reported. The first mobile device 802 may be configured to translate the AoA information (e.g., determine reciprocal direction) to determine a direction to the second mobile device 804. In an example, the respective locations of the mobile devices 802, 804 may be based on terrestrial and/or satellite technologies and may be used to determine an angle (e.g., direction, bearing) between the two devices. Other sensor inputs, such as from the IMU 270 and the camera 218, and/or from the BLE module 508 may be used to determine estimated locations of the mobile devices 802, 804 and establish the respective range and/or bearing information.

The first mobile device 802 may proceed along the trajectory 820 (i.e., based at least in part on the distance and direction information that is displayed to the user) to a third intermediate location 822c which is inside a UWB range 816 of the mobile devices 802, 804. The UWB range 816 is a region within which UWB signaling may be used to determine a distance between the first mobile device 802 and the second mobile device 804 (e.g., UWB signals may be received with sufficient energy to be used to determine the distance between the mobile devices 802, 804 (e.g., with at least a third threshold accuracy (e.g., an uncertainty below a third threshold uncertainty and/or a distance error below a third threshold distance error))). The third threshold accuracy may be different from, e.g., finer, than the second threshold accuracy (e.g., the third threshold uncertainty may be lower than the second threshold uncertainty and/or the third threshold distance error may be less than the second threshold distance error. A boundary 817 of the UWB range 816 may be established by measuring signal strengths of the UWB transmissions, station detection, and/or by other coverage area estimation techniques (e.g., locally stored look-up-tables, and/or network assistance information). While the mobile devices 802, 804 are within the UWB range 816, they may perform UWB ranging exchanges as described with respect to FIG. 7A to determine a fourth distance 830, and utilize the AoA techniques described with respect to FIG. 7B. Other distance and direction techniques may be used. The transition from the wide area direction finding information (e.g., based on terrestrial and/or satellite positioning), to the increased precision of D2D RAT signals such as WiFi RTT, UWB RTT, and AoA/AoE may provide for robust and precise finding operations for an extended range. Network assistance may be provided to increase security and to personalize the interactions based on user and/or operator preferences. For example, in user dense venues (e.g., stadiums, theme parks, urban canyons, etc.) centralized management of D2D RAT configurations may increase the quality of service for the finder and target devices.

The mobile device 802 may try to determine a range to the mobile device 804 using the most accurate (e.g., highest resolution) positioning technology that is available (to the mobile device 802) and with which a distance (range) between the mobile devices 802, 804 can be determined. For example, the mobile device 802 may use GNSS positioning to determine a location of the mobile device 802, and use a location of the mobile device 804 provided to the mobile device 802 to determine a range between the mobile devices 802, 804. The mobile device 802 may then use the positioning technology with the shortest range that contains the distance between the mobile devices 802, 804. For example, if the determined distance between the mobile devices 802, 804 is within the range 816, then the mobile device 802 will use UWB to determine an updated distance between the mobile devices 802, 804. The mobile device 802 may attempt to determine the distance between the mobile devices 802, 804 using positioning technologies in order of range. For example, the mobile device 802 may first attempt to determine the distance between the mobile devices 802, 804 using the most accurate (shortest range) positioning technology available to the mobile device 802, e.g., UWB signaling. If the distance is successfully determined, then the mobile device 802 may not attempt to determine the distance using any other positioning technology. If the distance is not successfully determined, then the mobile device 802 may attempt to determine the distance using a higher-range (e.g., then next-higher-range) positioning technology available to the mobile device, e.g., 5/6 GHz WiFi signaling. This process may continue until either the distance between the mobile devices 802, 804 is determined or the available positioning technology with the highest (i.e., greatest, longest) range has been used.

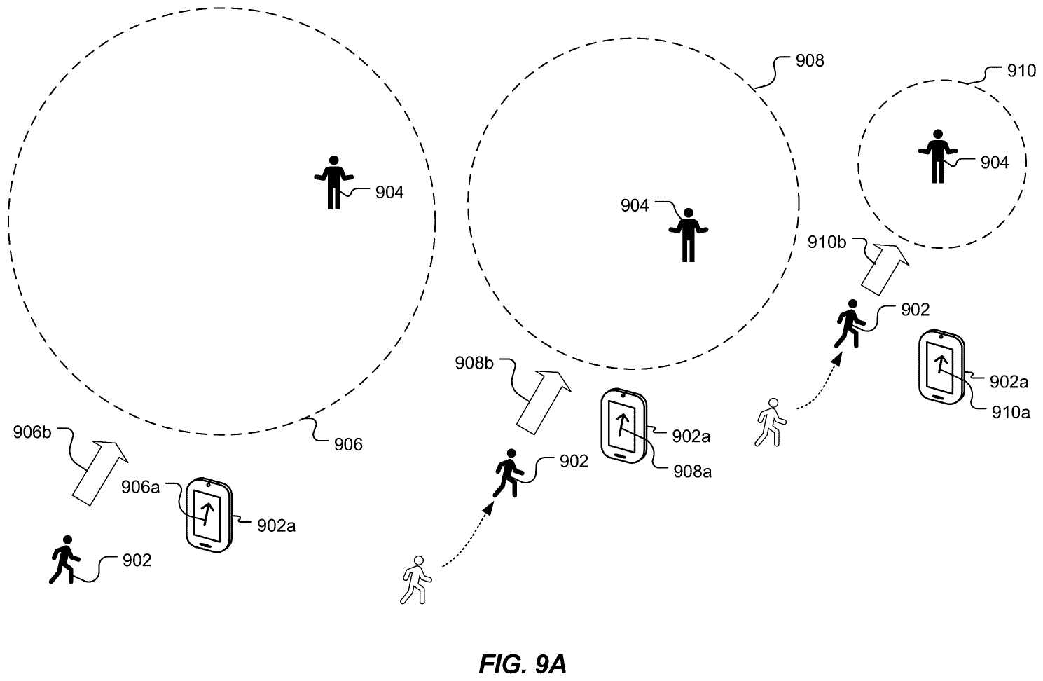

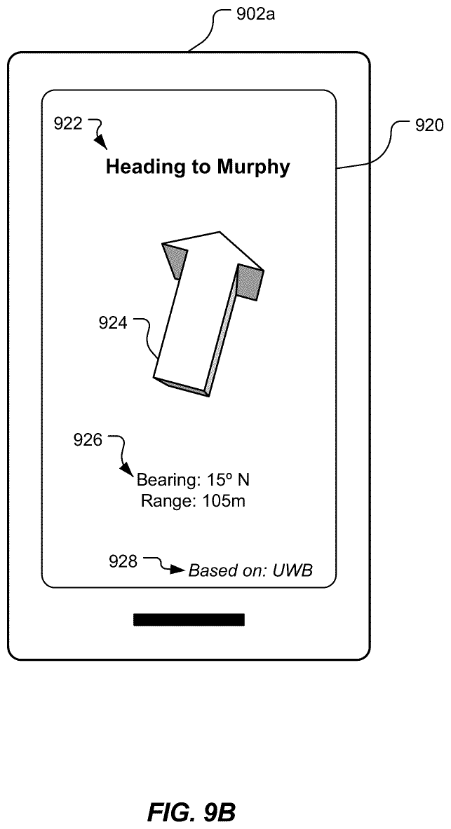

Referring to FIG. 9A, with further reference to FIG. 8, a diagram of example precision regions based on different radio access technologies is shown. The diagram includes an example finder 902 (e.g., a first user with mobile device 902a), and a target 904 (e.g., a second user with a second mobile device (not shown in FIG. 9A)). The finder 902 and the target 904 are depicted in relatively sized precision regions, such as a first precision region 906, a second precision region 908, and a third precision region 910. The first precision region 906 may be based on location information obtained by terrestrial and/or satellite signals. In general, the uncertainties associated with GNSS signals may generate larger location estimates for the finder 902 and the target 904, thus the first precision region 906 is relatively larger than the second and third precision regions 908, 910. The mobile device 902a may be configured with an application, or other service, to provide an indication to the finder 902 to assist in navigating to the target 904. In an example, the mobile device 902a may display an arrow to estimate a direction to the target 904. Signals from internal sensors, such as the magnetometers 271, the accelerometers 273, and the gyroscopes 274, may be utilized to generate the arrow displayed to the finder 902. A first arrow 906a displayed on the mobile device 902a may point the finder 902 in a direction 906b, indicating that the target 904 is in the center of the first precision region 906, when the target 904 is actually located some distance away from the center. The second precision region 908 may be based on measurements obtained with WiFi signals (e.g., RTT ranging) and GNSS (or other terrestrial positioning). The WiFi RTT measurements may improve the ranging accuracy and thus lead to an increase in precision. The second precision region 908 may be smaller than the first precision region 906, and a corresponding second arrow 908a displayed on the mobile device 902a may point the finder 902 in a direction 908b to a smaller area including the target 904. The third precision region 910 may be based on UWB exchanges which can generate distance (e.g., RTT) and direction (e.g., AoA) with a higher precision than WiFi exchanges. A third arrow 910a displayed on the mobile device 902a may direct the finder 902 in a direction 910b to a smaller region containing the target 904. The precision finding techniques provided herein may enable the mobile device 902a to progress through different positioning technologies (e.g., satellite and/or cellular, WiFi, BT, UWB, etc.) and may increase the precision of the distance and direction information provided to the finder 902 as each positioning technology is activated. The increased precision may be particularly important when the target 904 is in a crowded environment when a large number of individuals are located in a less precise area (e.g., the first precision region 906).

Referring to FIG. 9B, with further reference to FIG. 9A, an example user interface on the mobile device 902a is shown. In an example, the mobile device 902a may include some or all of the components of the UE 200, and the UE 200 may be an example of the mobile device 902a. The mobile device 902a may include a display device 920 configured to provide visual information to the finder 902. In an example, the visual information may include a target indication field 922. Target information such as a name, phone number, or other identifying information may be displayed in the target indication field 922. A vector information object 924 (e.g., an arrow or other icon indicating a direction) may be displayed to indicate the relative direction of the target. The direction of the vector information object 924 may be based at least in part on other sensor information in the mobile device 902a, such as the magnetometers 271, the accelerometers 273, and the gyroscopes 274, to provide a relative direction regardless of the orientation of the mobile device 902a. Range and bearing fields 926 may present distance and direction information based on different units (e.g., English, metric) and coordinate systems (e.g., magnetic bearing, true bearing (i.e., based on local variation and sensor deviation if known)). In an example, one or more gyroscopes 274 may be configured to align with true north. A precision field 928 may be configured to indicate one or more positioning technologies (e.g., terrestrial, satellite, WiFi, BT, UWB, Sidelink NR, mmWave, or other D2D RATs) which the current distance and direction information are based upon, and/or an uncertainty of the bearing and/or the range (e.g., +/−2° and/or +/−4 m). The precision field 928 may provide the finder 902 with feedback on the relative precision of the target location, which may influence the finder's visual search pattern when closing on the target. The precision field 928 may be icons representing the current positioning technology the range and bearing information is based on. For example, a first icon may depict a satellite, a second icon may depict a satellite and/or WiFi logo, a third icon may indicate a BT logo, and a fourth icon may depict a UWB logo. The user interface and icons are examples, and not limitations, as other visual, audio, and/or haptic outputs may be used to indicate the direction and/or range of the target. For example, the screen may indicate red, yellow, or green to indicate the relative direction of the target (e.g., green when the mobile device is moving towards the target, yellow when the movement is to the left of the target, and red when the movement is to the right of the target). Audio tones may be used to indicate the direction of the target, and different haptic indicators (e.g., vibration intensity and/or patterns) may be used to indicate the relative position of a target. Similarly, different tones or vibrations may be used to indicate changes in the precision field information. For example, a first tone and/or vibration for satellite-based precision, a second tone and/or vibration to indicate WiFi-based precision, and a third tone and/or vibration to indicate UWB-based precision may be used. Other tones and/or vibrations may be used for other radio technologies.

The single target depicted in the user interface in FIG. 9B is an example, and not a limitation. In an example, range and bearing information may be obtained for multiple targets and displayed in the user interface. For example, different vector information objects 924 may be presented to the user along with corresponding target identification information for multiple targets.

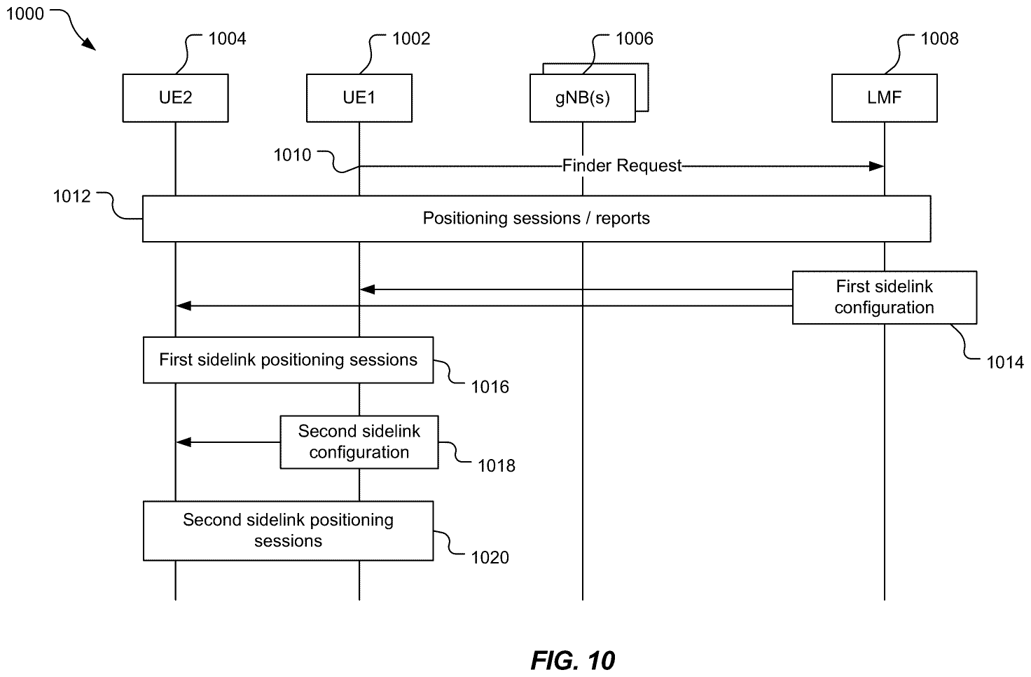

Referring to FIG. 10, an example signal and processing flow 1000 for network controlled precision finding operations includes stages shown. The flow 1000 is an example flow and not limiting. The flow 1000 may be altered, e.g., by having one or more messages and/or one or more stages added, removed, rearranged, combined, performed concurrently, and/or having one or more messages and/or one or more stages split into multiple messages and/or stages. The flow 1000 may utilize signaling protocols such as LPP, NRPPa, etc. as described with respect to FIG. 1. Other signaling techniques may also be used.

The flow 1000 may be utilized by a finding mobile device and a target mobile device, such as described with respect to FIG. 8. For example, a first UE 1002 may be designated as the finder device and a second UE 1004 may be designated as the target device. In this use case, both of the UEs 1002, 1004 are part of a network, such as the communication system 100, and may communicate with network entities such as one or more gNBs 1006 and an LMF 1008. The UEs 1002, 1004 may be smartphones associated with two users, but in other use cases, the UEs 1002, 1004 may include other devices such as asset tags, and onboard units (OBUs) in a vehicle. For example, the second UE 1004 may be an OBU in a rented vehicle in a crowded parking lot, and the first UE 1002 may be a smartphone operated by a user who forgot the vehicle type as well as the parking location. The UEs 1002, 1004 may be configured for other use cases.

In operation, in an example, the first UE 1002 may be configured to send one or more finder request messages 1010 to the LMF 1008 to initiate a finding session when the UEs 1002, 1004 are outside of D2D RAT range. At stage 1012, the LMF 1008 may configure one or more positioning sessions with the UEs 1002, 1004 to obtain position information. The UEs 1002, 1004 may obtain and report terrestrial positioning measurements (e.g., PRS measurements), or other location information such as respective position estimates based on terrestrial and/or satellite signals (e.g., GNSS). In an example, one or more gNBs 1006 may report uplink positioning measurement information such as Sounding Reference Signals (SRSs) for positioning transmitted by the UEs 1002, 1004. The LMF 1008 may provide location information to the first UE 1002 to enable long range finding based on the reported locations of the UEs, 1002, 1004.

At stage 1014, the LMF 1008 (or other network resource) may generate a first D2D RAT configuration to enable the UEs to perform an SL ranging exchange. In an example, the first D2D RAT configuration may be based on WiFi technology and the configuration may include information to enable the UEs 1002, 1004 to securely exchange timing messages. Other D2D RAT configuration information may also be generated. For example, the first D2D RAT configuration may be based on sidelink NR or sidelink PRS (SL-PRS) resources and the LMF 1008 may provide the SL-PRS resources in response to receiving the one or more finder request messages 1010. The LMF 1008 may provide first D2D RAT configuration information to the UEs 1002, 1004 via network signaling (e.g., LPP, RRC messages).

At stage 1016, the UEs 1002, 1004 may perform one or more first D2D RAT positioning sessions based on the first D2D RAT configuration. In an example, the first D2D RAT positioning sessions may be based on 2.4 GHz WiFi RTT exchanges as described with respect to FIG. 8. Other D2D RAT signal transfers may also be configured by the LMF 1008 and executed by the UEs 1002, 1004. In an example, the one or more first D2D RAT positioning sessions at stage 1016 may be initiated in response to receiving the first D2D RAT configuration information from the LMF 1008. Other triggers may also be used to initiate the first D2D RAT positioning sessions.

At stage 1018, the first UE 1002 may be configured to generate a second D2D RAT configuration to utilize in additional D2D RAT positioning sessions. The second D2D RAT positioning sessions may utilize a technology which will provide more precise range information as compared to the first D2D RAT positioning sessions. The second D2D RAT configuration may be based on a higher frequency WiFi RTT exchange (e.g., 5/6 GHz). The second D2D RAT configuration may be based on a UWB technology. For example, the UEs 1002, 1004 may be configured as Enhanced Ranging Devices (ERDEVs), with the first UE 1002 being configured to perform the role of a controller, and the second UE 1004 being configured to perform the role of a controlee. As the controller, the first UE 1002 may establish the parameters for a UWB ranging session and provide the session information to the controlee (e.g., the second UE 1004) via one or more Ranging Control Messages (RCMs). The RCM may include ranging parameters, such as channel information, ranging block and slot configurations, to enable the UEs 1002, 1004 to perform a time-scheduled or contention-free UWB ranging session. The second UE 1004, (i.e., controlee) may be configured to utilize the ranging parameters received from the first UE 1002 in the RCM. In an example, the first UE 1002 and the second UE 1004 may exchange RCMs to negotiate the second D2D RAT positioning session parameters. As described herein, the concepts of the controller and the controlee are based on an upper layer networking perspective, and roles of an initiator and responder may be used on the physical and medium access control (MAC) layers. Utilizing the ranging parameters included in the RCM, an initiator may be configured to initiate a ranging exchange by sending the first message of the exchange, such as a ranging initiation message (RIM).

At stage 1020, the UEs 1002, 1004 may perform one or more second D2D RAT positioning sessions based on the configuration information established at stage 1018.

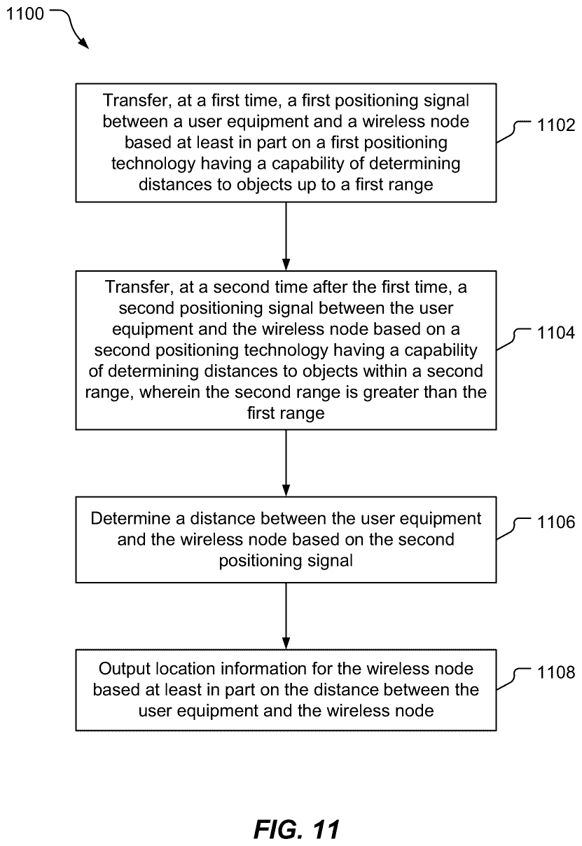

Referring to FIG. 11, with further reference to FIGS. 1-10, an example method 1100 for determining location information for a wireless node based on a distance between a user equipment and the wireless node includes the stages shown. The method 1100 is, however, an example and not limiting. The method 1100 may be altered, e.g., by having one or more stages added, removed, rearranged, combined, performed concurrently, and/or by having one or more single stages split into multiple stages. Using the method 1100, a UE may try to determine a distance with the most-accurate (e.g., shortest range) positioning technology available to the UE, and if unsuccessful, try one or more less accurate positioning technologies until a distance is determined or a least-accurate (highest-range) positioning technology available to the UE has been tried (e.g., all positioning technologies available to the UE have been tried).

At stage 1102, the method 1100 includes transferring, at a first time, a first positioning signal between the user equipment and the wireless node based at least in part on a first positioning technology having a capability of determining distances to objects up to a first range. A UE 200, including the processor 210 and the transceiver 215, is a means for transferring the first positioning signal. In an example, the first positioning technology may be based on UWB signaling, or based on 5/6 GHz WiFi RTT exchanges, or based on 2.4 GHz WiFi RTT exchanges. The first positioning technology may be based on UWB exchanges, which have a range that is typically less than WiFi. In an example, the first positioning technology may be based on a terrestrial positioning technique such as obtaining measurements for DL-PRS received by the wireless node and/or UL-SRS for positioning signals transmitted by the wireless node. The terrestrial positioning techniques may be based on, for example, PRS related measurements such as RSSI, cellular based RTT, RSTD, RSRP, and/or RSRQ. Other network based techniques such as TOA, and TDOA procedures may also be used. Due to limited range of the first positioning technology, the UE 200 may fail to determine a distance between the UE 200 and the wireless node such as another mobile device (e.g., if the UE 200 is the mobile device 804, the first positioning technology is UWB, and the mobile device 802 is at location 822b).

At stage 1104, the method 1100 includes transferring, at a second time after the first time, a second positioning signal between the user equipment and the wireless node based on a second positioning technology having a capability of determining distances to objects within a second range, wherein the second range is greater than the first range. The UE 200, including the processor 210 and the transceiver 215, is a means for transferring the second positioning signal. In an example, the second positioning technology may be based on D2D RAT signals transmitted by the wireless node. For example, WiFi RTT exchanges such as described with respect to FIG. 6 may be performed with the wireless node to determine the distance between the UE (e.g., the UE 200) and the wireless node. Other D2D RAT configurations, such as SL-PRS exchanges, may be used to determine the second distance. For example, BT technologies, such as BTCS may be used. In general, the range of the second positioning technology may be based on power output and/or signal strength limitations assigned to the technology. In commercial applications, WiFi based signaling is generally considered to have an increased range as compared to UWB signaling. Other signaling technologies may have similar physical and/or regulatory limitations which impact the effective range of the signals. As another example, the distance may be determined based at least in part on a GNSS position estimate. For example, referring to FIG. 8, the first mobile device 802 may be configured to receive a GNSS position estimate for the second mobile device 804 (i.e., the wireless node) and determine the distance between the UE and the wireless node based on the respective locations of the first and second mobile devices 802, 804.

At stage 1106, the method 1100 includes determining a distance between the user equipment and the wireless node based on the second positioning signal. The UE 200, including the processor 210 and the transceiver 215, is a means for determining the distance between the user equipment and the wireless node, e.g., based on an appropriate positioning method.

At stage 1108, the method 1100 includes outputting location information for the wireless node based at least in part on the distance between the user equipment and the wireless node. The UE 200, including the processor 210 and the user interface 216, is a means for outputting the location information. In an example, referring to FIG. 9B, the location information may be output as information on a display. For example, the location information may be a vector information object 924 and/or a distance field or other object configured to indicate the distance between the user equipment and the wireless node to a user. In an example, the location information may include location coordinates based on applying the distance between the user equipment and the wireless node and bearing information to a known location (e.g., the current location of a finder mobile device).

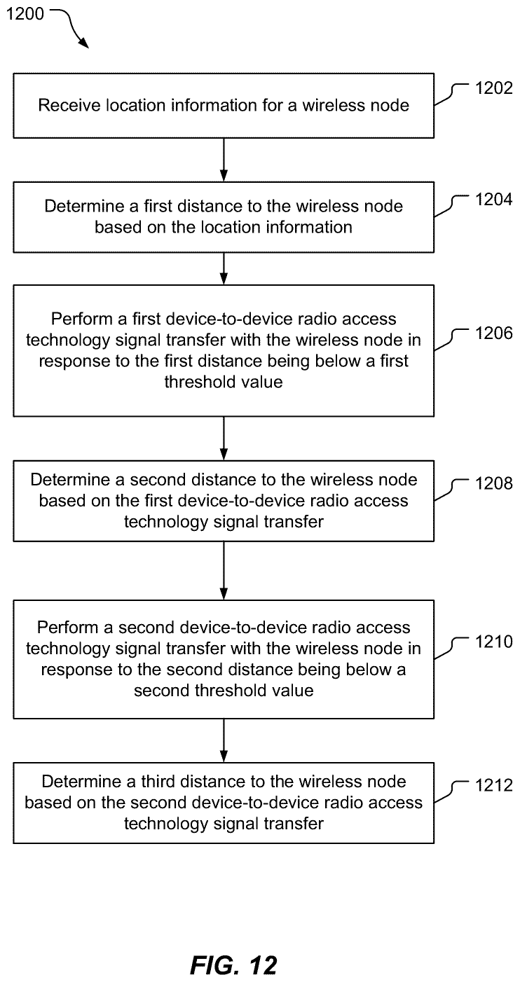

Referring to FIG. 12, with further reference to FIGS. 1-10, an example method 1200 for determining a distance to a wireless node includes the stages shown. The method 1200 is, however, an example and not limiting. The method 1200 may be altered, e.g., by having one or more stages added, removed, rearranged, combined, performed concurrently, and/or by having one or more single stages split into multiple stages.

At stage 1202, the method 1200 includes receiving location information to a wireless node. A UE 200, including the processor 210 and the transceiver 215, is a means for receiving the location information. In an example, a wireless network such as the communication system 100, may be configured to provide location information for wireless nodes in the network. For example, referring to FIG. 8, the first mobile device 802 may be configured to receive the location information from the gNB 806. The location information may be geographic coordinates based on terrestrial and/or satellite signals measured by the wireless node. In an example, the wireless node may be configured to send the location information via a messaging protocol (e.g., SMS, email, etc.). Other techniques may be used to receive the location information.

At stage 1204, the method 1200 includes determining a first distance to the wireless node based on the location information. The UE 200, including the processor 210, is a means for determining the first distance. The first distance may be computed based on a location of the finding device (e.g., the first mobile device 802) and the location information received at stage 1202 (e.g., the location of the target device). Direction information may also be computed based on the location information. In an example, a user interface such as described with respect to FIG. 9B, may be configured to present the first distance to the user (e.g., via a vector information object 924).

At stage 1206, the method 1200 includes performing a first D2D RAT signal transfer with the wireless node in response to the first distance being below a first threshold value. The UE 200, including the processor 210 and the transceiver 215, is a means for performing the first D2D RAT signal transfer. In an example, referring to FIG. 8, the first D2D RAT signal transfer may be based on 2.4 GHz WiFi and the first threshold may be based on the established 2.4 GHz WiFi range 812. The first threshold value may be a RSSI value that is associated with a range value. The first threshold may be based on expected range values stored in a data structure on a mobile device. The first D2D RAT signal transfer may be based on RTT exchanges utilizing WiFi technologies. Positioning messages based on other D2D RAT positioning techniques and frequency ranges may also be used to perform the first D2D RAT signal transfer. As an example, the first threshold value may be approximately 300 meters.

At stage 1208, the method 1200 includes determining a second distance to the wireless node based on the first D2D RAT signal transfer. The UE 200, including the processor 210 and the transceiver 215, is a means for determining the second distance. The RTT procedures such as described with respect to FIG. 6 may be used to obtain the timing information indicated at equation (1). The distance (range) to the wireless node may be calculated based on multiplying half the RTT value by the speed of light. Other RF ranging techniques may also be used to determine the second distance based on the first D2D RAT signal transfer.

At stage 1210, the method 1200 includes performing a second D2D RAT signal transfer with the wireless node in response to the second distance being below a second threshold value. The UE 200, including the processor 210 and the transceiver 215, is a means for performing the second D2D RAT signal transfer. In an example, referring to FIG. 8, the second D2D RAT signal transfer may be based on 5/6 GHz WiFi and the second threshold may be based on the established 5/6 GHz WiFi range 814. The second threshold value may be an RSSI value that is associated with a range value. The second threshold may be based on expected range values stored in a data structure on a mobile device. The second D2D RAT signal transfer may be based on RTT exchanges utilizing WiFi technologies. A transition from a 2.4 GHz WiFi frequency to a 5/6 GHz WiFi frequency may occur when the distance to a target is approximately 150 m. Positioning messages based on other D2D RAT positioning techniques and frequency ranges may also be used to perform the second D2D RAT signal transfer. For example, BT and/or UWB technologies may be utilized to perform the second D2D RAT signal transfer. In this example, the second threshold may be based on the UWB range 816. The second threshold value may be approximately 100 meters.

At stage 1212, the method includes determining a third distance to the wireless node based on the second D2D RAT signal transfer. The UE 200, including the processor 210 and the transceiver 215, is a means for determining the third distance. In an example, when the second D2D RAT signal transfer is based on a WiFi technology, the RTT procedures such as described with respect to FIG. 6 may be used to determine the third distance. In an example, when the second D2D RAT signal transfer is based in UWB protocols, the signal exchange described with respect to FIG. 7A may be used to determine the third distance. Other RF ranging techniques may also be used to determine the third distance based on the second D2D RAT signal transfer.

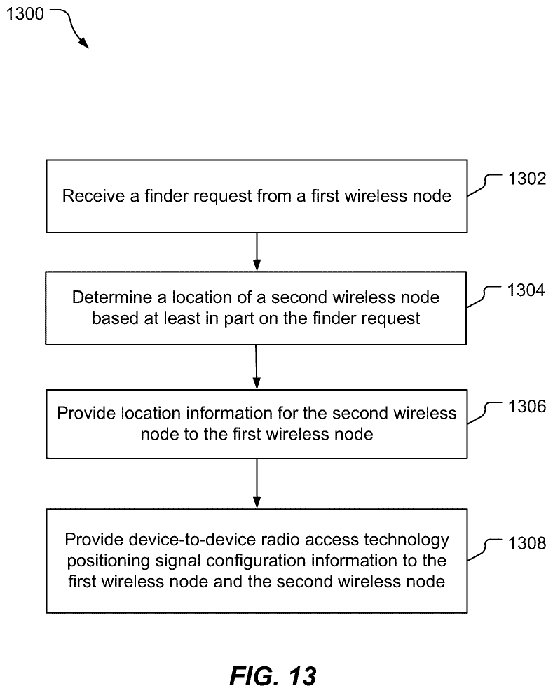

Referring to FIG. 13, with further reference to FIGS. 1-10, an example method 1300 for configuring a precise finding operation includes the stages shown. The method 1300 is, however, an example and not limiting. The method 1300 may be altered, e.g., by having one or more stages added, removed, rearranged, combined, performed concurrently, and/or by having one or more single stages split into multiple stages.

At stage 1302, the method 1300 includes receiving a finder request from a first wireless node. A server 400, such as the LMF 1008, including the processor 410 and the transceiver 415, is a means for receiving the finder request. In an example, referring to FIG. 10, a mobile device such as the first UE 1002 may be configured to send one or more finder request messages 1010 to the LMF 1008 to initiate a finding session. The finder request messages 1010 may include identification information for one or more target devices. In an example, the finder request messages may include capability information to indicate the D2D RAT signal transfer capabilities of the finder and/or target devices.

At stage 1304, the method 1300 includes determining a location of a second wireless node based at least in part on the finder request. The server 400, including the processor 410 and the transceiver 415, is a means for determining the location of the second wireless node. The first wireless node may be a finder device and the second wireless node may be a target device. In an example, the LMF 1008 may be configured to request position information and/or schedule positioning sessions with the one or more target devices indicated in the finder request messages. The one or more target devices may be configured to provide location information (e.g., latitude, longitude, altitude) based on GNSS measurements to the LMF 1008. In an example, the target devices may be configured to provide positioning measurements to the LMF 1008, and the LMF 1008 may be configured to determine the respective locations of the one or more target devices based at least in part on the positioning measurements.

At stage 1306, the method 1300 includes providing location information for the second wireless node to the first wireless node. The server 400, including the processor 410 and the transceiver 415, is a means for providing the location information. The LMF 1008 may be configured to store the target location information received or computed at stage 1304, and provide the location to the requesting finder device. For example, referring to FIG. 10, the location information may be provided to the first UE 1002 at stage 1012 with positioning reports. Other signaling techniques may be used to provide the finder device with the location information for the one or more target devices.

At stage 1308, the method 1300 includes providing D2D RAT positioning signal configuration information to the first wireless node and the second wireless node. The server 400, including the processor 410 and the transceiver 415, is a means for providing the D2D RAT positioning signal configuration information. In an example, the LMF 1008 may be configured to generate D2D RAT positioning signal configurations to enable the first and second wireless nodes to perform a SL ranging exchange. In an example, the D2D RAT positioning signal configuration information may be based on WiFi technology and the information may include information to enable the first and second wireless nodes to securely exchange timing messages. Other D2D RAT positioning signal configuration information may also be generated. For example, the D2D RAT positioning signal configuration information may be based on sidelink PRS (SL-PRS) resources and the LMF 1008 may provide the SL-PRS resources to the first and second wireless nodes.

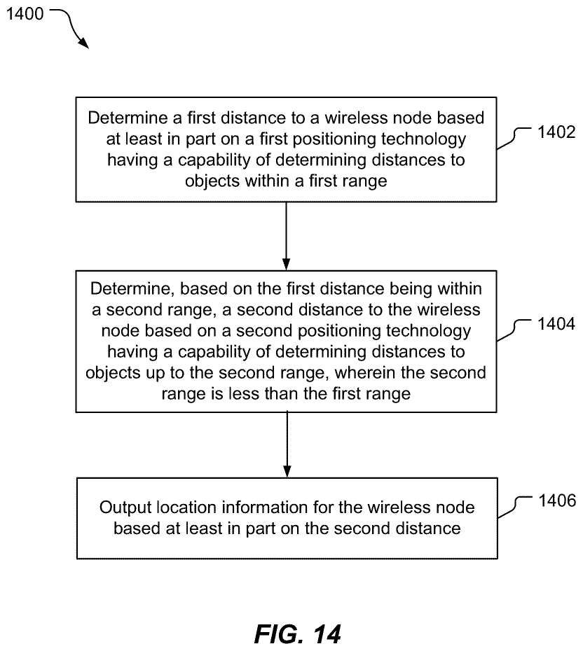

Referring to FIG. 14, with further reference to FIGS. 1-10, an example method 1400 for precision finding with two radio technologies includes the stages shown. The method 1400 is, however, an example and not limiting. The method 1400 may be altered, e.g., by having one or more stages added, removed, rearranged, combined, performed concurrently, and/or by having one or more single stages split into multiple stages.

At stage 1402, the method 1400 includes determining a first distance to a wireless node based at least in part on a first positioning technology having a capability of determining distances to objects within a first range. The UE 200, including a communications module 502, is a means for determining the first distance. In an example, the first positioning technology may be a GNSS based position estimate of the wireless node. The first distance may be determined based at least in part on the GNSS position estimate. For example, referring to FIG. 8, the first mobile device 802 may be configured to receive a GNSS position estimate for the second mobile device 804 (i.e., the wireless node) and determine the first distance based on the respective locations of the first and second mobile devices 802, 804. In an example, the first positioning technology may be based on a terrestrial positioning technique such as obtaining measurements for DL-PRS received by the wireless node and/or UL-SRS for positioning signals transmitted by the wireless node. The terrestrial positioning techniques may be based on, for example, PRS related measurements such as RSSI, cellular based RTT, RSTD, RSRP, and/or RSRQ. Other network-based techniques such as TOA, and TDOA procedures may also be used. In an example, the first positioning technology may be based on WiFi or BT as described herein. In some use cases, WiFi ranging exchanges may be utilized to determine AoA information (e.g., bearing). BT ranging may include BTCS techniques and may be configured to determine AoA information. Other ranging techniques may also be used.

At stage 1404, the method 1400 includes determining, based on the first distance being within a second range, a second distance to the wireless node based on a second positioning technology having a capability of determining distances to objects up to the second range, wherein the second range is less than the first range. The UE 200, including the communications module 502, is a means for determining the second distance. In general, the second positioning technology may be configured to provide a more accurate distance result for shorter distances, as compared to the first positioning technology utilized at stage 1402. The more-accurate positioning technology may be used when a distance using a less-accurate positioning technology is determined to be within a range of the more-accurate positioning technology (that can determine distances up to (no more than) the second range). Various combinations of first and second positioning technologies may be used. For example, when the first positioning technology is based on GNSS or terrestrial positioning, the second positioning technology may be WiFi, BT, UWB, or other device-to-device radio access technologies. When the first positioning technology is a WiFi technology, the second positioning technology may be a higher frequency WiFi based technology, BT, UWB or other device-to-device radio access technologies with operational ranges that are less than the WiFi technology used as the first positioning technology. When the first positioning technology is a BT technology (e.g., BTCS), the second technology may be UWB or other device-to-device radio access technologies with operational ranges that are less than the BT technology used as the first positioning technology. Other technology combinations may also be used.

At stage 1406, the method 1400 includes outputting location information for the wireless node based at least in part on the second distance. The UE 200, including the communications module 502, is a means for outputting the location information. In an example, referring to FIG. 9B, the location information may be output as information on a display. For example, the location information may be a vector information object 924 and/or a distance field or other object configured to indicate the second distance to a user. In an example, the location information may include location coordinates based on applying the second distance and bearing information to a known location (e.g., the current location of a finder mobile device).

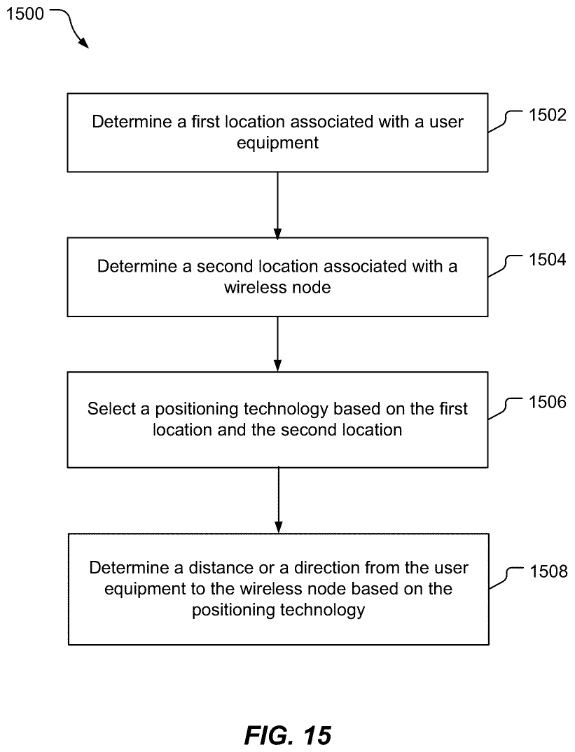

Referring to FIG. 15, with further reference to FIGS. 1-10, an example method 1500 for selecting a positioning technology includes the stages shown. The method 1500 is, however, an example and not limiting. The method 1500 may be altered, e.g., by having one or more stages added, removed, rearranged, combined, performed concurrently, and/or by having one or more single stages split into multiple stages.

At stage 1502, the method 1500 includes determining a location associated with a user equipment (UE). The UE 200, including the processor 210, the transceiver 215 or the SPS receiver 217, is a means for determining the location. In an example, the UE may be configured to determine a GNSS position estimate based on received satellite signals. In an example, the location may be based on a terrestrial positioning technique such as obtaining measurements for DL-PRS received by the transceiver 215. The terrestrial positioning techniques may be based on, for example, PRS related measurements such as RSSI, cellular based RTT, RSTD, RSRP, and/or RSRQ. Other network based techniques such as TOA, TDOA, and E-CID procedures may also be used. In an example, the location may be based on D2D RAT signal transfers with other stations as described herein. The UE may be configured to report the location to a network resource, such as the LMF 120.

At stage 1504, the method 1500 includes determining a location associated with a wireless node. The UE 200, including the processor 210, the transceiver 215 or the SPS receiver 217, is a means for determining the location. In an example, the wireless node may be configured to determine a GNSS position estimate based on received satellite signals. In an example, the wireless node may be configured to determine a location based on a terrestrial positioning technique such as obtaining measurements for DL-PRS received by the transceiver 215. The terrestrial positioning techniques may be based on, for example, PRS related measurements such as RSSI, cellular based RTT, RSTD, RSRP, and/or RSRQ. Other network based techniques such as TOA, TDOA, and E-CID procedures may also be used. In an example, the location may be based on D2D RAT signal transfers with other stations as described herein. The wireless node may be configured to report the location to a network resource, such as the LMF 120. Other network nodes, such as UEs, may be configured to obtain the location of the wireless node from the network resource.

At stage 1506, the method 1500 includes selecting a positioning technology based on the first location and the second location. The UE 200, including the processor 210, is a means for selecting the positioning technology. For example, referring to FIG. 8, the first location may correspond to the first intermediate location 822a (e.g., within the 2.4 GHz WiFi range 812), the second location may be the location of the second mobile device 804, and a WiFi RTT positioning technology utilizing the 2.4 GHz bands may be selected. The first location may correspond to the second intermediate location 822b, the second location may be the location of the second mobile device 804, and a WiFi RTT positioning technology utilizing the 5/6 GHz or the 2.4 GHz bands may be selected. The first location may correspond to the third intermediate location 822c, the second location may be the location of the second mobile device 804, and the selected positioning technology may include UWB ranging exchanges. In an example, WiFi RTT positioning technology utilizing the 5/6 GHz or the 2.4 GHz bands may be selected. In a example, multiple positioning technologies may be selected such that one positioning technology may be utilized to obtain distance and AoA information, and another positioning technology may be utilized to obtain distance and AoE information. The positioning technologies may be based on other device-to-device radio access technologies, such as sidelink NR and SL-PRS. The relationships between the locations of the UE and the wireless node (e.g., distance) and the available positioning technologies to select may be based on expected distance values stored in a data structure on the UE or the wireless node (e.g., look-up-tables, flat files, etc. stored in the memory 211). In an example, selecting the positioning technology may be based on 2D or 3D use cases. Some positioning technologies may have highly accurate 2D performance, but may not be capable of 3D measurements. Thus, for a 3D use case, a 3D capable positioning technology may be preferable.

At stage 1508, the method 1500 includes determining a distance or a direction from the user equipment to the wireless node based on the positioning technology. The UE 200, including the processor 210 and the transceiver 215, is a means for determining the distance or direction. In an example, the WiFi and UWB signal exchanges as described with respect to FIGS. 6-7B may be used to obtain distance and direction information. The direction information may be based on AoA measurements. AoE measurements may also be obtained. Other D2D RAT (e.g., sidelink NR, SL-PRS) signal transfers may be used to obtain distance and direction information.

### Implementation Examples

Implementation examples are provided in the following numbered clauses.

Clause 1. A method of determining location information for a wireless node based on a distance between a user equipment and the wireless node, comprising:
transferring, at a first time, a first positioning signal between the user equipment and the wireless node based at least in part on a first positioning technology having a capability of determining distances to objects up to a first range;
transferring, at a second time after the first time, a second positioning signal between the user equipment and the wireless node based on a second positioning technology having a capability of determining distances to objects within a second range, wherein the second range is greater than the first range;
determining the distance between the user equipment and the wireless node based on the second positioning signal; and outputting the location information for the wireless node based at least in part on the distance between the user equipment and the wireless node.

Clause 2. The method of clause 1 wherein the second positioning technology utilizes a global navigation satellite system.

Clause 3. The method of clause 1 wherein the first positioning technology is based at least in part on positioning reference signals received from one or more base stations in a wireless communication system.

Clause 4. The method of clause 1 wherein the second positioning technology utilizes one or more round trip time measurement sessions with a WiFi radio technology.

Clause 5. The method of clause 1 wherein the first positioning technology utilizes one or more signal exchanges for ultrawideband ranging.

Clause 6. The method of clause 1 further comprising determining a bearing to the wireless node based on the second positioning technology.

Clause 7. The method of clause 6 wherein outputting the location information includes displaying a vector information object based at least in part on the bearing and the distance between the user equipment and the wireless node.

Clause 8. The method of clause 1 further comprising outputting an indication of the second positioning technology and the distance between the user equipment and the wireless node.

Clause 9. The method of clause 8 wherein the indication of the second positioning technology is an icon.

Clause 10. A method for determining a distance to a wireless node, comprising:
receiving location information for the wireless node;
determining a first distance to the wireless node based on the location information;
performing a first signal exchange with the wireless node in response to the first distance being below a first threshold value;
determining a second distance to the wireless node based on the first signal exchange;
performing a second signal exchange with the wireless node in response to the second distance being below a second threshold value; and determining a third distance to the wireless node based on the second signal exchange.

Clause 11. The method of clause 10 further comprising outputting an indication of the first distance, an indication of the second distance, and an indication of the third distance.

Clause 12. The method of clause 10 further comprising determining a bearing to the wireless node based at least in part on the second signal exchange.

Clause 13. The method of clause 10 wherein the location information for the wireless node is received via a cellular network.

Clause 14. The method of clause 10 wherein the first signal exchange includes one or more round trip time measurement sessions with a WiFi radio technology utilizing a first frequency range, and the second signal exchange includes one or more round trip time measurement sessions with the WiFi radio technology utilizing a second frequency range that is higher than the first frequency range.

Clause 15. The method of clause 10 wherein the first signal exchange includes one or more round trip time measurement sessions with a WiFi radio technology, and the second signal exchange includes one or more signal exchanges for ultrawideband ranging.

Clause 16. The method of clause 10 further comprising receiving signal configuration information, wherein performing the first signal exchange is based at least in part on the signal configuration information.

Clause 17. The method of clause 16 wherein the signal configuration information is received from a server in a communication system.

Clause 18. The method of clause 10 wherein the wireless node is an asset tag.

Clause 19. The method of clause 10 wherein the wireless node is an onboard unit (OBU) in a vehicle.

Clause 20. The method of clause 10 wherein the wireless node is a user equipment.

Clause 21. A method for precision finding with two radio technologies, comprising:
determining a first distance to a wireless node based at least in part on a first positioning technology having a capability of determining distances to objects within a first range;
determining, based on the first distance being within a second range, a second distance to the wireless node based on a second positioning technology having a capability of determining distances to objects up to the second range, wherein the second range is less than the first range; and
outputting location information for the wireless node based at least in part on the second distance.

Clause 22. The method of clause 21 wherein the first positioning technology utilizes a global navigation satellite system, and the second positioning technology is a device-to-device radio access technology.

Clause 23. The method of clause 22 wherein the device-to-device radio access technology is one of a WiFi technology, a Bluetooth technology, or an ultrawideband technology.

Clause 24. The method of clause 21 wherein the first positioning technology is based at least in part on positioning reference signals received from one or more base stations in a wireless communication system, and the second positioning technology is a device-to-device radio access technology.

Clause 25. The method of clause 24 wherein the device-to-device radio access technology is one of a WiFi technology, a Bluetooth technology, or an ultrawideband technology.

Clause 26. The method of clause 21 wherein the first positioning technology utilizes a WiFi technology, and the second positioning technology utilizes a Bluetooth technology or an ultrawideband technology.

Clause 27. The method of clause 21 wherein the first positioning technology utilizes a Bluetooth technology, and the second positioning technology utilizes an ultrawideband technology.

Clause 28. The method of clause 21 further comprising determining a bearing to the wireless node based on the first positioning technology and the second positioning technology.

Clause 29. The method of clause 28 wherein outputting the location information includes displaying a vector information object based at least in part on the bearing to the wireless node.

Clause 30. The method of clause 21 further comprising outputting an indication of the first positioning technology and the first distance, and an indication of the second positioning technology and the second distance.

Clause 31. The method of clause 30 wherein the indication of the first positioning technology is a first icon, and the indication of the second positioning technology is a second icon.

Clause 32. An apparatus, comprising:
at least one memory;
at least one transceiver;
at least one processor communicatively coupled to the at least one memory and the at least one transceiver, and configured to:
   transfer, via the at least one transceiver at a first time, a first positioning signal between the apparatus and a wireless node based at least in part on a first positioning technology having a capability of determining distances to objects up to a first range;
   transfer, via the at least one transceiver at a second time after the first time, a second positioning signal to the wireless node based on a second positioning technology having a capability of determining distances to objects within a second range, wherein the second range is greater than the first range; and
   determine a distance between the apparatus and the wireless node based on the second positioning signal; and
   output location information for the wireless node based at least in part on the distance between the apparatus and the wireless node.

Clause 33. The apparatus of clause 32 wherein the second positioning technology utilizes a global navigation satellite system.

Clause 34. The apparatus of clause 32 wherein the first positioning technology is based at least in part on positioning reference signals received from one or more base stations in a wireless communication system.

Clause 35. The apparatus of clause 32 wherein the second positioning technology utilizes one or more round trip time measurement sessions with a WiFi radio technology.

Clause 36. The apparatus of clause 32 wherein the first positioning technology utilizes one or more signal exchanges for ultrawideband ranging.

Clause 37. The apparatus of clause 32 wherein the at least one processor is further configured to determine a bearing to the wireless node based on the second positioning technology.

Clause 38. The apparatus of clause 37 wherein the at least one processor is further configured to display a vector information object based at least in part on the bearing and the distance between the apparatus and the wireless node.

Clause 39. The apparatus of clause 32 wherein the at least one processor is further configured to output an indication of the second positioning technology and the distance between the apparatus and the wireless node.

Clause 40. The apparatus of clause 39 wherein the indication of the second positioning technology is an icon.

Clause 41. An apparatus, comprising:
at least one memory;
at least one transceiver;
at least one processor communicatively coupled to the at least one memory and the at least one transceiver, and configured to:
   receive location information for a wireless node;
   determine a first distance to the wireless node based on the location information;
   perform a first signal exchange with the wireless node in response to the first distance being below a first threshold value;
   determine a second distance to the wireless node based on the first signal exchange;
   perform a second signal exchange with the wireless node in response to the second distance being below a second threshold value; and
   determine a third distance to the wireless node based on the second signal exchange.

Clause 42. The apparatus of clause 41 wherein the at least one processor is further configured to output an indication of the first distance, an indication of the second distance, and an indication of the third distance.

Clause 43. The apparatus of clause 41 wherein the at least one processor is further configured to determine a bearing to the wireless node based at least in part on the second signal exchange.

Clause 44. The apparatus of clause 41 wherein the at least one processor is further configured to receive the location information for the wireless node via a cellular network.

Clause 45. The apparatus of clause 41 wherein the first signal exchange includes one or more round trip time measurement sessions with a WiFi radio technology utilizing a first frequency range, and the second signal exchange includes one or more round trip time measurement sessions with the WiFi radio technology utilizing a second frequency range that is higher than the first frequency range.

Clause 46. The apparatus of clause 41 wherein the first signal exchange includes one or more round trip time measurement sessions with a WiFi radio technology, and the second signal exchange includes one or more signal exchanges for ultrawideband ranging.

Clause 47. The apparatus of clause 41 wherein the at least one processor is further configured to receive signal configuration information and perform the first signal exchange based at least in part on the signal configuration information.

Clause 48. The apparatus of clause 47 wherein the at least one processor is further configured to receive the signal configuration information from a server in a communication system.

Clause 49. The apparatus of clause 41 wherein the wireless node is an asset tag.

Clause 50. The apparatus of clause 41 wherein the wireless node is an onboard unit (OBU) in a vehicle.

Clause 51. The apparatus of clause 41 wherein the wireless node is a user equipment.

Clause 52. An apparatus, comprising:
at least one memory;
at least one transceiver;
at least one processor communicatively coupled to the at least one memory and the at least one transceiver, and configured to:
   determine a first distance to a wireless node based at least in part on a first positioning technology having a capability of determining distances to objects within a first range;
   determine, based on the first distance being within a second range, a second distance to the wireless node based on a second positioning technology having a capability of determining distances to objects up to the second range, wherein the second range is less than the first range; and
   output location information for the wireless node based at least in part on the second distance.

Clause 53. The apparatus of clause 52 wherein the first positioning technology utilizes a global navigation satellite system, and the second positioning technology is a device-to-device radio access technology.

Clause 54. The apparatus of clause 53 wherein the device-to-device radio access technology is one of a WiFi technology, a Bluetooth technology, or an ultrawideband technology.

Clause 55. The apparatus of clause 52 wherein the first positioning technology is based at least in part on positioning reference signals received from one or more base stations in a wireless communication system, and the second positioning technology is a device-to-device radio access technology.

Clause 56. The apparatus of clause 55 wherein the device-to-device radio access technology is one of a WiFi technology, a Bluetooth technology, or an ultrawideband technology.

Clause 57. The apparatus of clause 52 wherein the first positioning technology utilizes a WiFi technology, and the second positioning technology utilizes a Bluetooth technology or an ultrawideband technology.

Clause 58. The apparatus of clause 52 wherein the first positioning technology utilizes a Bluetooth technology, and the second positioning technology utilizes an ultrawideband technology.

Clause 59. The apparatus of clause 52 wherein the at least one processor is further configured to determine a bearing to the wireless node based on the first positioning technology and the second positioning technology.

Clause 60. The apparatus of clause 59 wherein the at least one processor is further configured to display a vector information object based at least in part on the bearing to the wireless node.

Clause 61. The apparatus of clause 52 wherein the at least one processor is further configured to output an indication of the first positioning technology and the first distance, and an indication of the second positioning technology and the second distance.

Clause 62. The apparatus of clause 61 wherein the indication of the first positioning technology is a first icon, and the indication of the second positioning technology is a second icon.

Clause 63. A method for selecting a positioning technology, comprising: determining a first location associated with a user equipment;
determining a second location associated with a wireless node;
selecting the positioning technology based on the first location and the second location; and
determining a distance or a direction from the user equipment to the wireless node based on the positioning technology.

Clause 64. The method of clause 63 wherein the positioning technology is based on one or more radio frequency signal exchanges between the user equipment and the wireless node via a device-to-device radio access technology.

Clause 65. The method of clause 64 wherein the device-to-device radio access technology includes sidelink NR.

Clause 66. The method of clause 63 wherein the direction from the user equipment is based on an angle of arrival measurement.

Clause 67. The method of clause 63 wherein the direction from the user equipment is based on an angle of elevation measurement.

Clause 68. The method of clause 63 wherein the direction from the user equipment is based on an angle of arrival measurement and an angle of elevation measurement.

Clause 69. The method of clause 63 wherein the positioning technology utilizes a WiFi signaling protocol or a ultrawideband signaling protocol.

Clause 70. An apparatus for determining location information for a wireless node, comprising:
means for transferring, at a first time, a first positioning signal between the apparatus and the wireless node based at least in part on a first positioning technology having a capability of determining distances to objects up to a first range;
transferring, at a second time after the first time, a second positioning signal between the apparatus and the wireless node based on a second positioning technology having a capability of determining distances to objects within a second range, wherein the second range is greater than the first range;
means for determining a distance between the apparatus and the wireless node based on the second positioning signal; and
means for outputting the location information for the wireless node based at least in part on the distance between the apparatus and the wireless node.

Clause 71. An apparatus for determining a distance to a wireless node, comprising:
means for receiving location information for the wireless node;
means for determining a first distance to the wireless node based on the location information;
means for performing a first signal exchange with the wireless node in response to the first distance being below a first threshold value;
means for determining a second distance to the wireless node based on the first signal exchange;
means for performing a second signal exchange with the wireless node in response to the second distance being below a second threshold value; and
means for determining a third distance to the wireless node based on the second signal exchange.

Clause 72. An apparatus for precision finding with two radio technologies, comprising:
means for determining a first distance to a wireless node based at least in part on a first positioning technology having a capability of determining distances to objects within a first range;
means for determining, based on the first distance being within a second range, a second distance to the wireless node based on a second positioning technology having a capability of determining distances to objects up to the second range, wherein the second range is less than the first range; and
means for outputting location information for the wireless node based at least in part on the first distance or the second distance.

Clause 73. An apparatus for selecting a positioning technology, comprising:
means for determining a first location associated with a user equipment;
means for determining a second location associated with a wireless node;
means for selecting the positioning technology based on the first location and the second location; and
means for determining a distance or a direction from the user equipment to the wireless node based on the positioning technology.

Clause 74. A non-transitory processor-readable storage medium comprising processor-readable instructions configured to cause one or more processors of an apparatus to determine location information for a wireless node, comprising code for:
transferring, at a first time, a first positioning signal between the apparatus and the wireless node based at least in part on a first positioning technology having a capability of determining distances to objects up to a first range;
transferring, at a second time after the first time, a second positioning signal between the apparatus and the wireless node based on a second positioning technology having a capability of determining distances to objects within a second range, wherein the second range is greater than the first range;
determining a distance between the apparatus and the wireless node based on the second positioning signal; and
outputting the location information for the wireless node based at least in part on the distance between the apparatus and the wireless node.

Clause 75. A non-transitory processor-readable storage medium comprising processor-readable instructions configured to cause one or more processors to determine a distance to a wireless node, comprising code for:
receiving location information for the wireless node;
determining a first distance to the wireless node based on the location information;
performing a first signal exchange with the wireless node in response to the first distance being below a first threshold value;
determining a second distance to the wireless node based on the first signal exchange;
performing a second signal exchange with the wireless node in response to the second distance being below a second threshold value; and determining a third distance to the wireless node based on the second signal exchange.

Clause 76. A non-transitory processor-readable storage medium comprising processor-readable instructions configured to cause one or more processors to utilize precision finding with two radio technologies, comprising code for:
determining a first distance to a wireless node based at least in part on a first positioning technology having a capability of determining distances to objects within a first range;
determining, based on the first distance being within a second range, a second distance to the wireless node based on a second positioning technology having a capability of determining distances to objects up to the second range, wherein the second range is less than the first range; and
outputting location information for the wireless node based at least in part on the first distance or the second distance.

Clause 77. A non-transitory processor-readable storage medium comprising processor-readable instructions configured to cause one or more processors to select a positioning technology, comprising code for:
determining a first location associated with a user equipment;
determining a second location associated with a wireless node;
selecting the positioning technology based on the first location and the second location; and
determining a distance or a direction from the user equipment to the wireless node based on the positioning technology.

### OTHER CONSIDERATIONS

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C,” or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

What is claimed is:

1. A method for precision finding with two radio technologies, comprising:
determining a first distance to a wireless node based at least in part on a first positioning technology having a capability of determining distances to objects within a first range;
determining, based on the first distance being within a second range, a second distance to the wireless node based on a second positioning technology having a capability of determining distances to objects up to the second range, wherein the second range is less than the first range; and
outputting location information for the wireless node based at least in part on the second distance.

2. The method of claim 1 wherein the first positioning technology utilizes a global navigation satellite system, and the second positioning technology is a device-to-device radio access technology.

3. The method of claim 2 wherein the device-to-device radio access technology is one of a WiFi technology, a Bluetooth technology, or an ultrawideband technology.

4. The method of claim 1 wherein the first positioning technology is based at least in part on positioning reference signals received from one or more base stations in a wireless communication system, and the second positioning technology is a device-to-device radio access technology.

5. The method of claim 4 wherein the device-to-device radio access technology is one of a WiFi technology, a Bluetooth technology, or an ultrawideband technology.

6. The method of claim 1 wherein the first positioning technology utilizes a WiFi technology, and the second positioning technology utilizes a Bluetooth technology or an ultrawideband technology.

7. The method of claim 1 wherein the first positioning technology utilizes a Bluetooth technology, and the second positioning technology utilizes an ultrawideband technology.

8. The method of claim 1 further comprising determining a bearing to the wireless node based on the first positioning technology and the second positioning technology.

9. An apparatus, comprising:
at least one memory;
at least one transceiver;
at least one processor communicatively coupled to the at least one memory and the at least one transceiver, and configured to:
determine a first distance to a wireless node based at least in part on a first positioning technology having a capability of determining distances to objects within a first range;
determine, based on the first distance being within a second range, a second distance to the wireless node based on a second positioning technology having a capability of determining distances to objects up to the second range, wherein the second range is less than the first range; and
output location information for the wireless node based at least in part on the second distance.

10. The apparatus of claim 9 wherein the first positioning technology utilizes a global navigation satellite system, and the second positioning technology is a device-to-device radio access technology.

11. The apparatus of claim 10 wherein the device-to-device radio access technology is one of a WiFi technology, a Bluetooth technology, or an ultrawideband technology.

12. The apparatus of claim 9 wherein the first positioning technology is based at least in part on positioning reference signals received from one or more base stations in a wireless communication system, and the second positioning technology is a device-to-device radio access technology.

13. The apparatus of claim 12 wherein the device-to-device radio access technology is one of a WiFi technology, a Bluetooth technology, or an ultrawideband technology.

14. The apparatus of claim 9 wherein the first positioning technology utilizes a WiFi technology, and the second positioning technology utilizes a Bluetooth technology or an ultrawideband technology.

15. The apparatus of claim 9 wherein the first positioning technology utilizes a Bluetooth technology, and the second positioning technology utilizes an ultrawideband technology.

16. The apparatus of claim 9 wherein the at least one processor is further configured to determine a bearing to the wireless node based on the first positioning technology and the second positioning technology.

17. The apparatus of claim 16 wherein the at least one processor is further configured to display a vector information object based at least in part on the bearing to the wireless node.

18. The apparatus of claim 9 wherein the at least one processor is further configured to output an indication of the first positioning technology and the first distance, and an indication of the second positioning technology and the second distance.

19. The apparatus of claim 18 wherein the indication of the first positioning technology is a first icon, and the indication of the second positioning technology is a second icon.

20. An apparatus for precision finding with two radio technologies, comprising:
means for determining a first distance to a wireless node based at least in part on a first positioning technology having a capability of determining distances to objects within a first range;
means for determining, based on the first distance being within a second range, a second distance to the wireless node based on a second positioning technology having a capability of determining distances to objects up to the second range, wherein the second range is less than the first range; and
means for outputting location information for the wireless node based at least in part on the first distance or the second distance.
